(19) United States
(12) Patent Application Publication
(10) Pub. No.: US 2026/0266508 A1
(43) Pub. Date: Sep. 10, 2026

(54) CHARGING SYSTEM AND CHARGING CRADLE FOR FOOD TRANSPORTATION SYSTEMS

(71) Applicant: VESTURE LLC, Asheboro, NC (US)

(72) Inventor: Byron C. Owens, Asheboro, NC (US)

(21) Appl. No.: 19/665,000

(22) Filed: Apr. 30, 2026

Related U.S. Application Data
(63) Continuation of application No. 19/007,930, filed on Jan. 2, 2025.
Application No. 19/007,930 is a continuation of application No. 17/607,628, filed on Apr. 30, 2020, now abandoned.
(60) Provisional application No. 62/840,942, filed on Apr. 30, 2019.

(51) Int. Cl. F24H 3/02; A45C 7/00; A45C 11/20; A47J 36/24; A47J 47/14; B65D 81/38; F25D 3/08

(52) U.S. Cl. CPC F24H 3/022; A47J 36/2494; A47J 47/14; A47J 47/145; B65D 81/3848; F25D 3/08; A45C 7/0077; A45C 11/20; F25D 2331/8011

(57) ABSTRACT

In one aspect, a food delivery temperature charging system, temperature charging cradle systems and food transportation system are described herein. In some embodiments, the food delivery temperature charging system contains a temperature charging cradle system including a base unit including a first temperature adjustment unit generating hot or cold air, a backing affixed to the base unit, and a channel duct affixed to the backing, wherein the first temperature adjustment unit is connected to the channel duct so that the channel duct permits free flow of the first temperature medium to a charging station. The food delivery temperature charging system further includes a charging station containing a horizontal shelf for holding a food storage system including a shelf temperature medium portal, which is connected to a channel duct so that the first temperature medium is conveyed from the fully enclosed channel duct to the temperature medium portal.

### CROSS REFERENCE TO RELATED APPLICATIONS

This application is a continuation of, and claims priority under 35 U.S.C. § 120 to, U.S. patent application Ser. No. 19/007,930, which is continuation of, and claims priority under § 120 to, U.S. patent application Ser. No. 17/607,628, which is a U.S. national stage patent application of international patent application PCT/US20/30830, filed Apr. 30, 2020, which international patent application claims priority under 35 U.S.C. § 119 to U.S. provisional patent application 62/840,942, filed Apr. 30, 2019, the entirety of which is hereby incorporated by reference herein. The disclosure of the provisional patent application is contained in the appendix to the specification, incorporated herein by reference.

### BACKGROUND

The present disclosure relates to food delivery temperature charging systems for charging a food transportation system including a temperature charging cradle system and a food storage system and methods of using such systems, including for temperature management of prepared food.

The transport of food, especially prepared food, from one location to another is an area of increasing concern. A number of food transport systems or containers have been developed for food transport and delivery, including for so called “last mile” delivery of prepared foods. However, some previous food transport systems suffer from one or more disadvantages, especially for the transportation of prepared foods that have been previously cooked, assembled, or otherwise prepared by a food preparer, and that are ready for consumption. So called “fresh-prepared” foods can be particularly challenging to transport in an acceptable manner, since these foods are not commercially produced (such as canned foods or other “off the shelf” foods are commercially produced) but are instead prepared upon receipt of an order from an end user (or consumer) or only shortly before (e.g., within 60 minutes, 30 minutes, 15 minutes, 10 minutes, or 5 minutes) such an order is expected to be received. Disadvantages of some previous systems include, but are not necessarily limited to, the inability to control the temperature of different foods or food types that have different temperature requirements and bulkiness when not in use.

### SUMMARY

In one aspect, the food delivery temperature charging systems, temperature charging cradle systems and food transportation systems, or containers, or bags are described herein.

Such systems or containers or bags, in some cases, can provide one or more advantages compared to some existing systems, containers, or bags. In some embodiments, for example, the food transportation systems, container, or bag described herein can provide improved temperature control or maintenance of products such as food placed within the systems, container, or bag, including in a “dual temperature” manner.

In some embodiments, a food delivery temperature charging system described herein contains a temperature charging cradle system including a base unit including a first temperature adjustment unit generating a first temperature medium, a vertically upwardly facing backing affixed to the base unit, and at least one fully enclosed channel duct affixed to the vertically upwardly facing backing, wherein the first temperature adjustment unit is connected to said fully enclosed channel duct so that the one fully enclosed channel duct permits free flow of the first temperature medium to a charging station. The food delivery temperature charging system further includes a charging station containing a horizontal shelf for holding a food storage system, the at least one horizontal shelf generally extending perpendicular outwardly from the vertical upward facing backing and affixed to the vertical upward facing backing wherein said at least one horizontal shelf comprises at least one shelf temperature medium portal wherein the shelf temperature medium portal is connected to the at least one fully enclosed channel duct so that the first temperature medium is conveyed from the fully enclosed channel duct to the temperature medium portal. Other possible advantages are further described hereinbelow.

In some preferred embodiments, a food transportation system, container, or bag described herein comprises a food transportation system positioned on the at least one horizontal shelf wherein the food transportation system comprises a phase change material (PCM) disposed in the interior volume of the food transportation system and a food storage compartment, the food storage compartment defined by a floor, one or more side walls, and a lid, and a food storage compartment portal that connects with the shelf temperature medium portal so the first temperature medium is conveyed from the shelf temperature medium portal through the food storage compartment portal into the food transportation system, charging the phase change material (PCM) at the desired temperature, as described further hereinbelow. It is to be understood, however, that in some preferred embodiments, the temperature medium does not itself enter the food storage compartment or come into contact with food stored in the food storage compartment.

Moreover, in another aspect, a system or container or bag described herein also includes a temperature charging cradle system including a base unit having a first temperature adjustment unit generating a first temperature medium, a vertically upwardly facing backing affixed to the base unit, and at least one fully enclosed channel duct affixed to the vertically upwardly facing backing, wherein the first temperature adjustment unit is connected to said fully enclosed channel duct so that the one fully enclosed channel duct permits free flow of the first temperature medium to a charging station, and a horizontal shelf for holding a food storage system container or bag, the shelf generally extending perpendicular outwardly from the vertical upward facing backing and affixed to the vertical upward facing backing wherein the shelf includes a shelf temperature medium portal connected to the channel duct so that the first temperature medium is conveyed from the duct to the temperature medium portal, as described further hereinbelow.

In some embodiments, a food transportation system, container, or bag described herein comprises a food storage compartment portal so that the food storage compartment portal of the first food storage compartment interconnects with a shelf temperature medium portal so that a first temperature medium is conveyed from the shelf portal through the food storage compartment portal into the first food storage compartment charging the PCM or PCMs at the desired temperature, and food storage compartment portal of a second food storage compartment interconnects with the shelf temperature medium portal so that the second temperature medium is conveyed from the shelf temperature medium portal through the food storage compartment portal into the second food storage compartment charging the phase change materials at the desired temperature (which second desired temperature can be different than the first desired temperature), as described further hereinbelow.

In another aspect, methods of storing and/or transporting food (or other products) are described herein. In some preferred embodiments, the food is prepared food. In some cases, such a method comprises placing the food (or other product) in the interior volume of a system, container, or bag described herein (such as a system, container, or bag described hereinabove). The method further comprises transporting the food (or other product) from a first location to a second location and removing the food (or other product) from the interior volume of the system at the second location. Moreover, in some embodiments, the method does not comprise attaching the system (or container or bag) to an electrical power supply while transporting the food (or other product) from the first location to the second location. Further, in some implementations, the system (or container or bag) comprises a phase change material (PCM) disposed in the interior volume of the system, and the method further comprises heating or cooling the PCM above or below a phase transition temperature of the PCM prior to placing the food in the interior volume of the container.

In another aspect, the food delivery temperature charging systems, temperature charging cradle systems or food transportation systems as described further hereinbelow can be used in portable devices and fixed devices wherein the portable devices include delivery vehicles, aircraft including commercial, military, private and transportation aircraft, transportation trucks, water ships including passenger and freighter ships, trains, and fixed devices including restaurants, hotels and hotel rooms, entertainment locations, educational facilities, offices, and homes.

These and other implementations are described in more detail in the detailed description which follows.

### BRIEF DESCRIPTION OF THE DRAWINGS

FIG. 1 illustrates a perspective view of a food delivery temperature charging system according to one embodiment described herein.

FIG. 2 illustrates a backside view of the temperature charging cradle system of FIG. 1, with schematic illustration of the modularity of the system.

FIG. 3 illustrates a rear view of the temperature charging cradle system of FIG. 2.

FIG. 4 illustrates a side sectional view of a food transportation system positioned on a shelf of the temperature charging cradle system of FIGS. 1 and 2.

FIG. 5 illustrates a front and top perspective view of a food transportation system according to one embodiment described herein.

FIG. 6 illustrates a perspective view of a front and side of the food transportation system of FIG. 5.

FIG. 7 illustrates a front and side perspective view of the food transportation system of FIG. 5

FIG. 8 illustrates a rear perspective view of the food transportation system of FIG. 5.

FIG. 9 illustrates a side and top perspective view of one embodiment of a food transportation system described herein where two lids are in an open position.

FIG. 10 illustrates a side and top perspective view of one embodiment of a food transportation system described herein where two lids are in an open position.

FIG. 11 illustrates Table 1.

### DETAILED DESCRIPTION

Implementations and embodiments described herein can be understood more readily by reference to the following detailed description, examples, and drawings. Elements, apparatus, and methods described herein, however, are not limited to the specific implementations presented in the detailed description, examples, and drawings. It should be recognized that these implementations are merely illustrative of the principles of the present disclosure. Numerous modifications and adaptations will be readily apparent to those of skill in the art without departing from the spirit and scope of the disclosure. In addition, all ranges disclosed herein are to be understood to encompass any and all subranges subsumed therein. For example, a stated range of“1.0 to 10.0” should be considered to include any and all subranges beginning with a minimum of 1.0 or more and ending with a maximum value of 10.0 or less, e.g., 1.0 to 5.3, or 4.7 to 10.0, or 3.6 to 7.9. Similarly, as will be clearly understood, a stated range of“1 to 10” should be considered to include any and all subranges beginning with a minimum of 1 or more and ending with a maximum value of 10 or less, e.g., 1 to 6, or 7 to 10, or 3.6 to 7.9.

All ranges disclosed herein are also to be considered to include the end points of the range, unless expressly stated otherwise. For example, a range of “between 5 and 10,”“from 5 to 10,” or“5-10” should generally be considered to include the end points of 5 and 10.

In the following description, exemplary food delivery temperature charging systems, temperature charging cradle system, and food transportation systems are described. However, the described food delivery temperature charging systems, temperature charging cradle systems, and food transportation systems are not limited to only transporting food but can also be used to transport any object that requires heating or cooling, such as medicines, chemical reagents, transplant organs, blood and tissue samples, and the like.

For purposes of brevity and conciseness, food delivery temperature charging systems, temperature charging cradle systems, and food transportations systems described herein will sometimes be referred to as simply a “system” or “systems”.

### I. Food Delivery Temperature Charging Systems

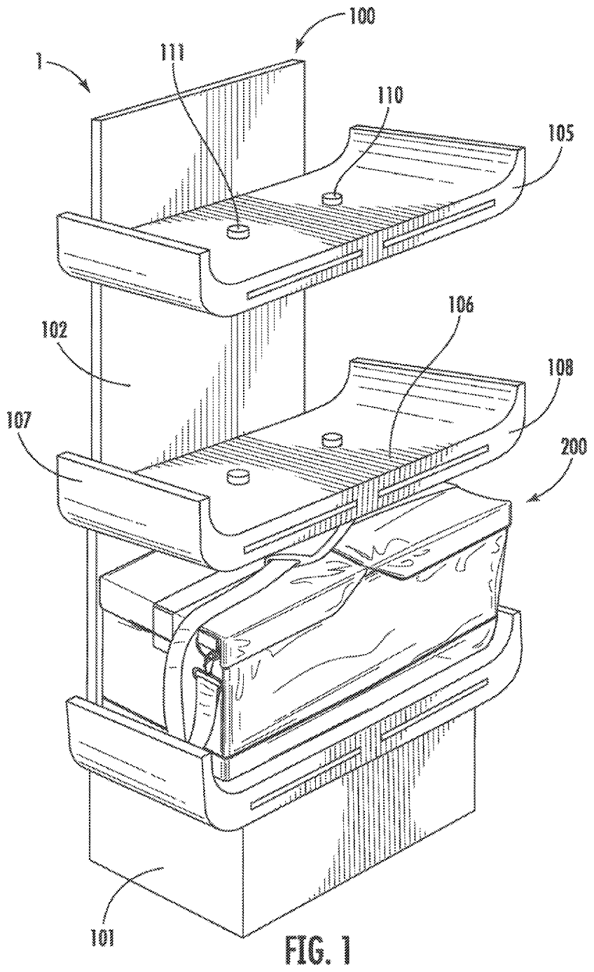

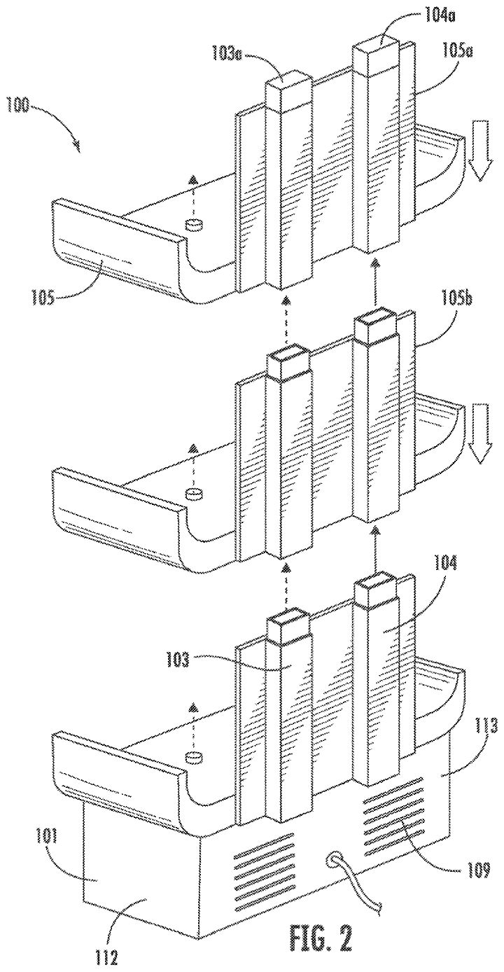

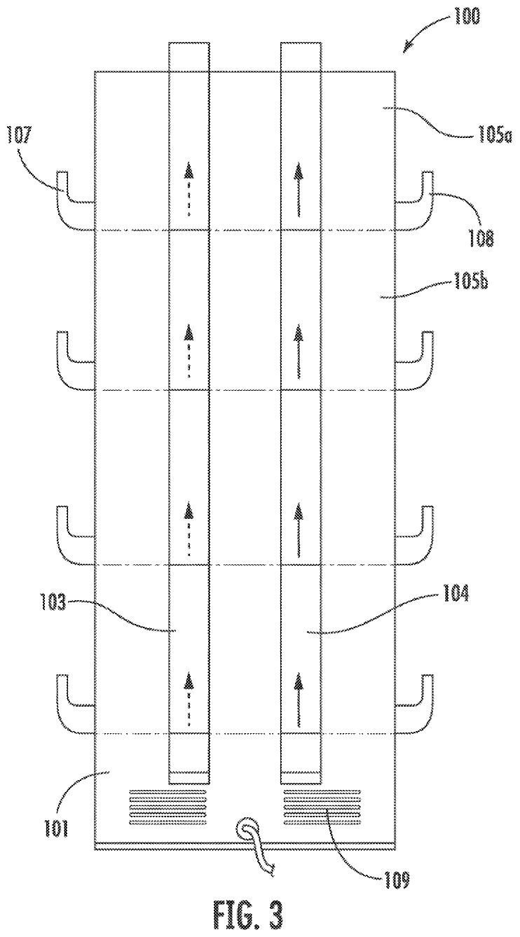

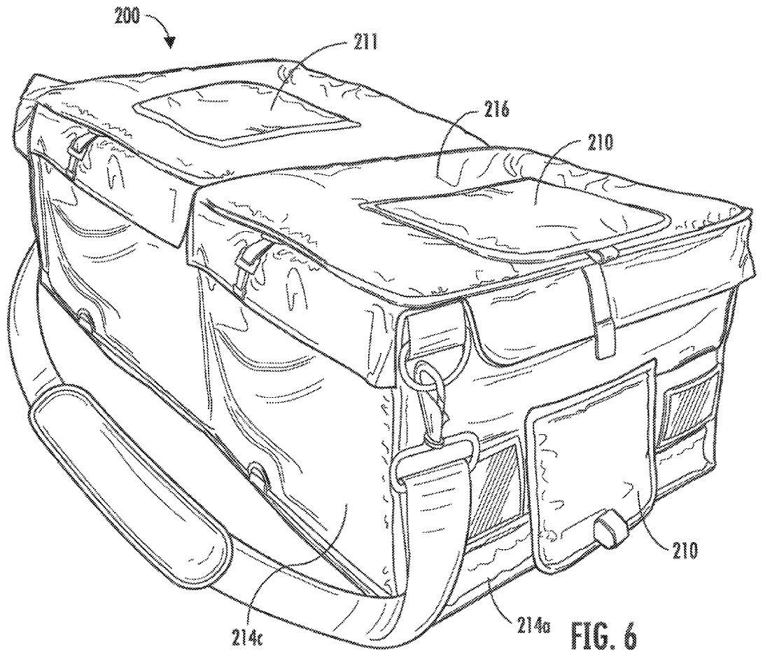

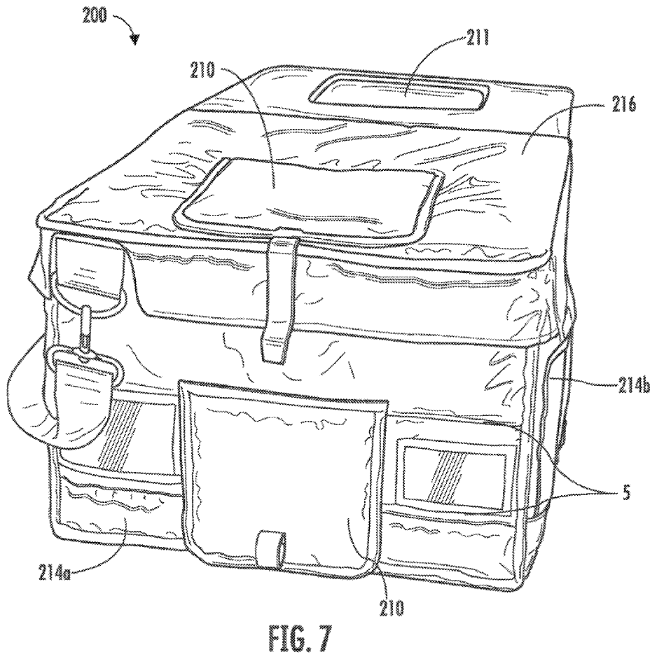

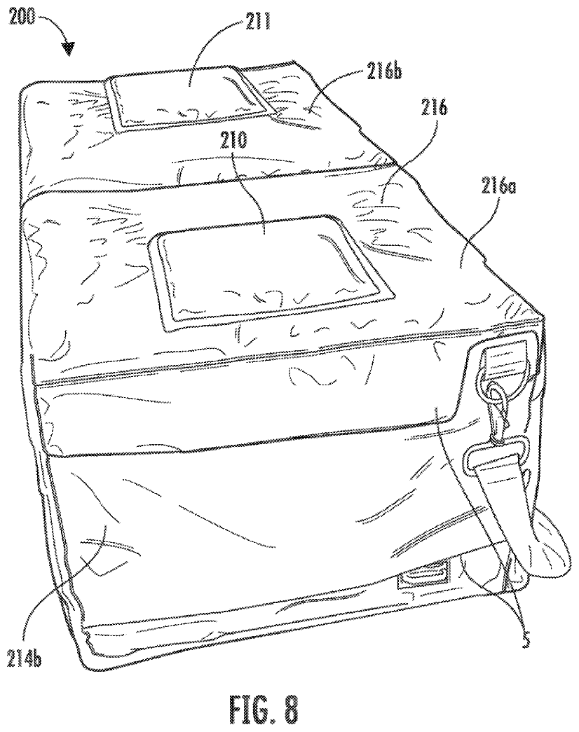

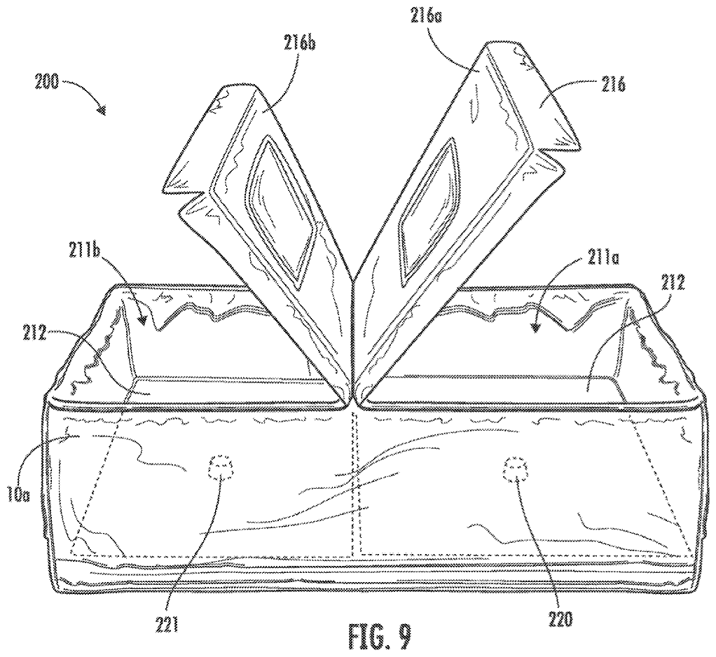

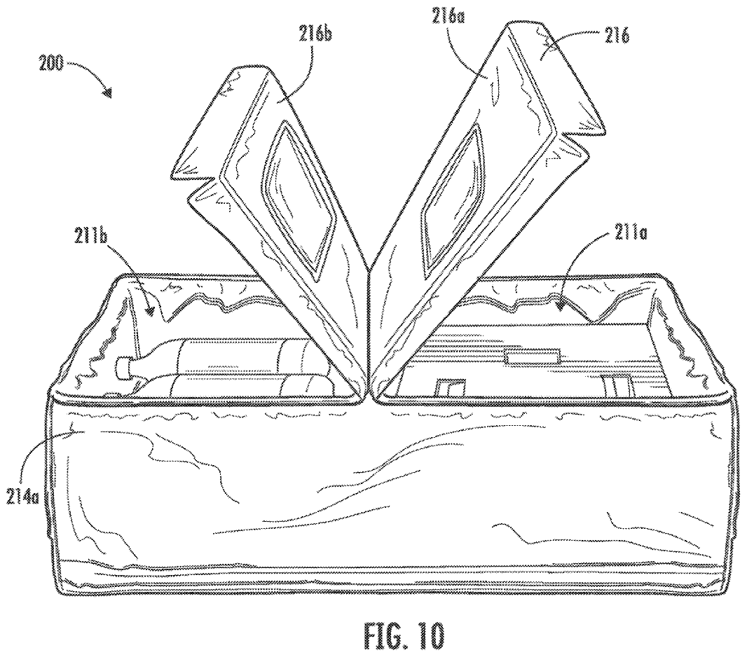

In one aspect, food delivery temperature charging systems 1, temperature charging cradle systems 100, and food transportations systems 200 are described herein, with reference to FIGS. 1-10. As generally shown in at least FIGS. 1-10, a food delivery temperature charging system 1 described herein comprises a temperature charging cradle system 100 comprising a base unit 101 comprising a first temperature adjustment unit 112 generating a first temperature medium, a vertically upwardly facing backing 102 affixed to the base unit 101, at least one fully enclosed channel duct 103 affixed to the vertically upwardly facing backing 102, wherein the first temperature adjustment unit 112 is connected to said fully enclosed channel duct 103 so that the one fully enclosed channel duct 103 permits free flow of the first temperature medium to a charging station 120, the charging station 120 comprising at least one horizontal shelf 125 for holding a food storage system 200, the at least one horizontal shelf 125 generally extending perpendicular outwardly from the vertical upward facing backing 102 and affixed to the vertical upward facing backing 102 wherein said at least one horizontal shelf 125 comprises at least one shelf temperature medium portal 110 wherein the shelf temperature medium portal 110 is connected to the at least one fully enclosed channel duct 103 so that the first temperature medium is conveyed from the fully enclosed channel duct 103 to the shelf temperature medium portal 110.

In another aspect, food delivery temperature charging systems 1, temperature charging cradle systems 100, and food transportations systems 200 are described herein to comprise a temperature charging cradle 100 comprising a base unit 101 comprising a first temperature adjustment unit 112 generating a first temperature medium and a second temperature adjustment unit 113 generating a second temperature medium. Generally, for obtaining electrical power, the food delivery temperature charging systems 1 would be plugged into the building's electrical system, e.g., using a normal outlet (where it is to be understood that the system is mounted on a wall or other structure or otherwise installed in a building; however, it is further to be understood that the electrical system of a vehicle could also be used, in the event a system described herein were installed or mounted in a vehicle). The first temperature adjustment unit 112 generating a first temperature medium, hot air for example, and a second temperature adjustment unit 113 generating a second temperature medium, cold air for example, can be any heating or cooling unit not inconsistent with the objectives of the disclosure, as long as it provides hot or cold air. In some preferred embodiments, a compressor of a freezer or refrigeration room or area, or a compressor of a heating, ventilation, and air condition (HVAC) system of the building is used to provide hot or cold air.

The temperature charging cradle 100 further comprises a vertically upwardly facing backing 102 affixed to the base unit 101, at least two fully enclosed channel ducts 103 and 104 affixed to the vertically upwardly facing backing 102, wherein the first temperature adjustment unit 112 is connected to one of the fully enclosed channel duct 103 and the second temperature adjustment unit 113 is connected to the fully enclosed channel duct 104 so that one fully enclosed channel duct 103 conveys the first temperature medium from the first temperature adjustment unit 112 and the second fully enclosed channel duct 104 conveys the first temperature medium, cold air, second temperature adjustment unit 112. The transfer of the heated or cooled air can be carried out using any HVAC-type or similar air transfer system (ducts, compressors, fans, etc.) not inconsistent with the objectives of the present disclosure. As the heating/cooling units push the air through the ducts 103, 104, through the shelf to the bag and creating a pressure in the air flow system as would be experienced with an HVAC system in a room of a building. In some preferred embodiments, the air flow and/or pressure within a system described herein is not greater and/or more pressurized than provided by a typical freezer or refrigeration room compressor or by a typical HVAC system in a building.

The temperature charging cradle 100 further comprises at least one horizontal shelf 105 for holding a food storage system 200, the at least one horizontal shelf 105 generally extending perpendicular outwardly from the vertical upward facing backing 102 and affixed to the vertical upward facing backing 102 wherein the at least one horizontal shelf 105 comprises at least two shelf temperature medium portals 110 and 111 each individually connected to one of the at least two fully enclosed channel ducts 103 and 104 so that the first temperature medium, hot air, is conveyed from the fully enclosed channel duct 103 to the temperature medium portal 110 and the second temperature medium, cold air, is conveyed from the fully enclosed channel duct 104 to the temperature medium portal 111. Any suitable air conveyance piping or conduit is sufficient to convey the hot and cold air from the duct to the temperature medium portal 110,111.

In another aspect, food delivery temperature charging systems 1, temperature charging cradle systems 100, and food transportations systems 200 as described herein to comprise a food transportation system 200 positioned on the at least one horizontal shelf 105 wherein the food transportation system 200 comprises phase change material disposed in the interior volume of the food transportation system 200 and a first food storage compartment 210 and a second food storage compartment 211, each food storage compartment defined by a floor 212, one or more side walls 214, and a lid 216, and each food storage compartment comprises a food storage compartment portal 220, 221 so that the food storage compartment portal 220 of the first food storage compartment 210 interconnects with the shelf temperature medium portal 110 so that the first temperature medium, hot air, is conveyed from the shelf portal 110 through the food storage compartment portal into the phase change materials at the desired temperature, and food storage compartment portal 221 of the second food storage compartment interconnects with the shelf temperature medium portal 111 so that the first temperature medium, cold air, is conveyed from the shelf temperature medium portal 111 through the food storage compartment portal charging the phase change materials at the desired temperature. The hot and cold air do not enter the food storage compartments but only come into physical contact with the compartment housing the phase change materials.

In another aspect, methods of storing and releasing or otherwise managing thermal energy, hot and cold temperatures of each compartment, are described herein. In some implementations, such a method comprises attaching thermal energy storage system comprising a first temperature adjustment unit 112 and the second temperature adjustment unit 113 described herein to the food transportation system. The thermal energy storage system (or thermal energy management system) can be any thermal energy storage system (or thermal energy management system) but as described hereinabove, in this case includes hot air and cold air.

Moreover, as described further herein, the temperature medium can be any external fluid not inconsistent with the objectives of the present disclosure. In some implementations, for instance, the temperature medium comprises air, in particular, hot and cold air. Moreover, the temperature medium can be a liquid or a gas. A liquid fluid, in some embodiments, comprises a glycol, such as ethylene glycol, propylene glycol, and/or polyalkylene glycol. In some instances, a liquid fluid comprises liquid water or consists essentially of liquid water. A gaseous fluid, in some embodiments, comprises air.

In addition, as described further herein, the external source of the temperature medium can be any external source not inconsistent with the objectives of the present disclosure. In some preferred implementations, the external source of the temperature medium is a source of heating or cooling, or a source of waste heat. In some cases, for instance, the external source of the external fluid comprises an HVAC chiller. A compressor may also be used.

Methods described herein, in some embodiments, further comprise forcing a first portion of the temperature medium through the heat exchange region or compartment of the temperature medium system (e.g., the region containing PCM). That is, the temperature medium enters the heat exchange region through a proximal end and exits through a distal end of the region, having been in thermal contact with the PCM. Moreover, for example, the first portion of the temperature medium can enter the heat exchange region at a first or initial temperature (T1) and exit the heat exchange region at a second temperature (T2). Additionally, in some preferred embodiments, T1 and T2 are different. In some cases, T1 is higher than T2. Alternatively, in other instances, T1 is lower than T2.

The food delivery temperature charging system 1 may further comprise a the first temperature medium, hot air, and the second temperature medium, cold air, wherein cold air and hot air are conveyed from the first temperature adjustment unit 112 and the second temperature adjustment unit 113 to the at least two shelf temperature medium portals 110 and 111, each individually connected to one of the at least two fully enclosed channel ducts 103 and 104 so that the first temperature medium, hot air, is conveyed from the fully enclosed channel duct 103 to the temperature medium portal 110 and the second temperature medium, cold air, is conveyed from the fully enclosed channel duct 104 to the temperature medium portal 111. The hot and cold air can be conveyed from the channel duct 103, 104, to the at least two shelf temperature medium portals 110 and 111 by any suitable air conveying means not inconsistent with the system. In some preferred embodiment, the at least two shelf temperature medium portals 110 and 111 and the food transportation system, container or bag portals are electrically controlled valves, and the ports on the shelf can “snap into” the ports on the bag.

The food delivery temperature charging system 1 may further comprise a the first food storage compartment 211 is a hot compartment and the second food storage compartment 212 is a cold compartment, the first temperature adjustment unit 112 generates a medium having a temperature of 50° C. or more (e.g., 50-100° C.), and the second temperature adjustment unit 113 generates a medium having a temperature of 15° C. or less (e.g., 0-15° C. or 0-10° C.).

The food delivery temperature charging system may further comprise a base unit 101 comprises a venting system to reduce temperature buildup in the base unit 101. The venting system can be any suitable commercial unit not inconsistent with the objectives of the disclosure, as long as it vents the base unit 101.

The food delivery temperature charging system may further comprise at least one horizontal shelf 105 that may be cradle shaped wherein the at least one horizontal shelf 105 comprises a flat horizontal area 106, and upward directed ends 107 and 108 for proper alignment of the food transportation system 200. The vertically upwardly facing backing 102 and the at least one horizontal shelf 105 may be segmented modular units 105a, 105b wherein each segmented modular unit 105a, 105b comprising enclosed channel ducts 103 and 104 affixed to the vertically upwardly facing backing 102 and said at least one horizontal shelf 105, and wherein the enclosed channel ducts 103 and 104 further comprise a cap 103a and 104b to seal each enclosed channel duct 103 and 104. The segmented modular units 105a, 105b, may be coupled together by fit, bolts, brackets or other suitable commercial means so the segmented modular units 105a, 105b remain affixed.

The food delivery temperature charging system 1 may further comprise a food transportation system 200 comprising the interior volume of each food storage compartment 211, 212 is defined by four orthogonal side walls, which may be formed from a fabric (such as nylon or a polyalkylene fabric). The side walls may be formed from other materials also, such as a plastic material or a film material. In general, the material used to form the interior or exterior walls of the bag (or a portion thereof) is not particularly limited.

The food delivery temperature charging system 1 may further comprise a food storage compartment 211 that is a hot compartment 211a and is sized to from 50% to 90% of the size of the total compartment and a second food storage compartment 212 is a cold compartment and is sized to from 10% to 50% of the size of the size of the total compartment. The lid 216 comprises two center-hinged lids 216a and 216b wherein the center-lid 216a covers the hot compartment 211a and the center-lid 216b covers the cold compartment 211b. Alternatively, it is also possible for both compartments to be “cold” compartments or for both compartments to be “hot” compartments.

The food delivery temperature charging system 1 may further comprise a thermal status indicator 20 indicating a visual or auditory indication related to the temperature status of the food transportation system 200 or of a food (or other product) storage compartment of a bag. Moreover, the temperature status can correspond to a desired delivery, storage, or consumption temperature of the food (or other product) disposed in the bag or to be disposed in the bag. The at least one horizontal shelf 105 may further include LED indicators, red for hot and blue for cold, to show that the food transportation system 200, container or bag is fully charged and ready for use.

The food delivery temperature charging system 1 may further comprise a food transportation system 200 comprising one or more phase change materials having a phase transition temperature corresponding to a desired delivery temperature of the food, one or more thermally insulating materials disposed in, or forming interior or exterior walls of, the one or more food storage compartments, an indicator light for showing the status of a phase change material in a charged or uncharged state, a magnetic closure for the food storage compartment, including, optionally, a positive closure mechanism, one or more additional food storage compartments and/or one or more additional phase change materials for storing and/or transporting a food at a temperature different from the desired delivery temperature; and one or more security and/or monitoring hardware and/or software items, including, optionally for controlling and/or monitoring the opening and closing of a food storage compartment.

It is further to be understood that, during the course of a method described herein, in some implementations, the first portion of the temperature medium participates in thermal energy transfer or heat exchange with the PCM disposed in the container. For example, in some cases, the first portion of the temperature medium transfers thermal energy or heat to the PCM, thereby lowering the temperature of the first portion of the external fluid. Additionally, in some such instances, the PCM stores at least a portion of the transferred thermal energy as latent heat (e.g., by undergoing a phase transition, such as a transition from a solid state to a liquid state). A temperature medium described herein may also be used to “freeze” (or take thermal energy from) a PCM, as opposed to “melting” (or giving thermal energy to) the PCM. It is generally to be understood that the phase transition temperature of a PCM used in a system described herein is selected to correspond to (or be close to, such as within 2, 3, or 5° C. of) a desired temperature of the payload (e.g., the food or other product). Moreover, in some cases, the temperature medium (e.g., hot or cold air) that is used to “charge” a specific PCM has a temperature that is at least 5° C., at least 10° C., at least 15° C., or at least 20° C. higher or lower than the phase transition temperature of the relevant PCM. In some cases, therefore, the PCM (e.g., on a “hot” side or a “cold” side of a two-compartment or dual-temperature food delivery bag described herein) has a phase transition temperature that is both within 2, 3, or 5° C. of a desired storage, delivery, or consumption temperature of the food, and also at least 5, 10, 15, or 20° C. (e.g., 5-30° C., 5-25° C., 5-20° C., 10-30° C., or 10-20° C.) lower or higher than the temperature of the hot or cold air used to charge the PCM. It is thus to be understood that a system described herein can comprise a fist PCM having a first phase transition temperature and a second PCM having a second phase transition temperature, wherein the first and second phase transition temperatures are different and wherein the first phase transition temperature has a value relative to a first food storage, delivery, or consumption temperature and relative to a first charging medium temperature as described hereinabove, and the second phase transition temperature similarly has a value relative to a second food storage, delivery, or consumption temperature and relative to a second charging medium temperature. In such an instance, the first and second food storage, delivery, or consumption temperatures can be different, and the first and second charging medium temperatures can be different. Such phase transition temperatures are further described below.

Moreover, in some cases, differing PCMs for differing food storage compartments can be “charged” other than using a charging cradle and system described herein. For example, in some embodiments, a two-compartment food delivery bag is described in which the bag dos not necessarily comprise ports as described herein, and in which the PCM or heat exchange regions are not necessarily segregated from the food storage compartments. For instance, in some such cases, a food delivery bag described herein comprises a first food storage compartment in thermal contact with a first PCM and also comprises a second food storage compartment in thermal contact with a second PCM. In some such cases, the first and second PCMs are disposed within the respective food storage compartments, e.g., in a pouch or sleeve or merely lying on the floor of the compartments or disposed within side walls forming the compartments. In some such cases, the PCMs can be “charged” (or made to undergo a phase transition suitable for providing heat or cold or other temperature control to the relevant food the specific PCM is in contact with) in any manner not inconsistent with the present disclosure. The manner of charging may be different than described herein with respect to a charging cradle. Instead, in some cases, charging can be carried out by placing a “cold” PCM (with a relatively low phase transition temperature) in a freezer or refrigerator for a time period sufficient to freeze at least 50%, at least 60%, at least 70%, or at least 80% of the mass of the PCM, or by placing a “hot” PCM (with a relatively high phase transition temperature) in a microwave or other oven for a time period sufficient to “melt” or induce another phase transition in at least 50%, at least 60%, at least 70%, or at least 80% of the mass of the PCM. In some such embodiments, therefore, the bag need not include the various compartments and features described herein related to charging with a charging cradle described herein. The bag can, however, have other features described herein, such as features described in Section III hereinbelow.

Any PCM not inconsistent with the objectives of the present disclosure may be used in a system or method described herein. Moreover, the PCM (or combination of PCMs) used in a particular instance can be selected based on a relevant product storage, delivery, or consumption temperature range for the specific product's end use or application.

For example, in some cases, a PCM has a phase transition temperature within a range suitable for storing, delivering, or consuming cold food or pharmaceuticals (such as −20 to −50° C., −20 to 0° C., 0 to 10° C., 2 to 8° C., or 10 to 15° C.) or for “room temperature” items (such as 15 to 25° C.). In other instances, a PCM has a phase transition temperature within a range suitable for storing, delivery, or consuming hot food (such as such as 50-100° C., 50-95° C., 50-90° C., or 65-80° C.). In some embodiments, the PCM has a phase transition temperature within one of the ranges of Table 1 of FIG. 11.

Further, a PCM of a system or method described herein can either absorb or release energy using any phase transition not inconsistent with the objectives of the present disclosure. For example, the phase transition of a PCM described herein, in some embodiments, comprises a transition between a solid phase and a liquid phase of the PCM, or between a solid phase and a mesophase of the PCM. A mesophase, in some cases, is a gel phase. Thus, in some instances, a PCM undergoes a solid-to-gel transition.

Moreover, in some cases, a PCM or mixture of PCMs has a phase transition enthalpy of at least about 50 kJ/kg or at least about 100 kJ/kg. In other embodiments, a PCM or mixture of PCMs has a phase transition enthalpy of at least about 150 kJ/kg, at least about 200 kJ/kg, at least about 300 kJ/kg, or at least about 350 kJ/kg. In some instances, a PCM or mixture of PCMs has a phase transition enthalpy between about 50 kJ/kg and about 350 kJ/kg, between about 100 kJ/kg and about 350 kJ/kg, between about 100kJ/kg and about 220 kJ/kg, or between about 100 kJ/kg and about 250 kJ/kg.

In addition, a PCM of a system or method described herein can have any composition not inconsistent with the objectives of the present disclosure. In some embodiments, for instance, a PCM comprises an inorganic composition. In other cases, a PCM comprises an organic composition. In some instances, a PCM comprises a salt hydrate. Suitable salt hydrates include, without limitation, CaCk·6H2O, Ca(NC>3)2·3H2O, NaSCri·IOH2O, Na(N03)2·6H2O, Zn(N0₃)₂·2H2O, FeCh·2H₂0, Co(N0₃)₂·6H₂0, Ni(N0₃)₂·6H₂0, MnCk·4H₂0, CFbCOONa·3H₂0, L1C2H3O2·2H₂0, MgCk·4H₂0, NaOH·H₂0, Cd(N0₃)₂·4H₂0, Cd(N0₃)₂·IH2O, Fe(N0₃)₂·6H₂0, NaAl(S0₄)₂·12H₂0, FeS0₄·7H₂0, Na₃P0₄·12H₂0, Na₂B₄0₇·lOFhO, Na₃P0₄·12H₂0, LiCFpCOO·2H₂0, and/or mixtures thereof.

In other embodiments, a PCM comprises a fatty acid. A fatty acid, in some embodiments, can have a C4 to C28 aliphatic hydrocarbon tail. Further, in some embodiments, the hydrocarbon tail is saturated. Alternatively, in other embodiments, the hydrocarbon tail is unsaturated. In some embodiments, the hydrocarbon tail can be branched or linear. Non limiting examples of fatty acids suitable for use in some embodiments described herein include caprylic acid, capric acid, lauric acid, myristic acid, palmitic acid, stearic acid, arachidic acid, behenic acid, lignoceric acid, and cerotic acid. In some embodiments, a PCM described herein comprises a combination, mixture, or plurality of differing fatty acids. For reference purposes herein, it is to be understood that a chemical species described as a “Cn” species (e.g., a“C4” species or a“C28” species) is a species of the identified type that includes exactly “n” carbon atoms. Thus, a C4 to C28 aliphatic hydrocarbon tail refers to a hydrocarbon tail that includes between 4 and 28 carbon atoms.

In some embodiments, a PCM comprises an alkyl ester of a fatty acid. Any alkyl ester not inconsistent with the objectives of the present disclosure may be used. For instance, in some embodiments, an alkyl ester comprises a methyl ester, ethyl ester, isopropyl ester, butyl ester, or hexyl ester of a fatty acid described herein. In other embodiments, an alkyl ester comprises a C2 to C6 ester alkyl backbone or a C6 to C12 ester alkyl backbone. In some embodiments, an alkyl ester comprises a C12 to C28 ester alkyl backbone. Further, in some embodiments, a PCM comprises a combination, mixture, or plurality of differing alkyl esters of fatty acids. Non-limiting examples of alkyl esters of fatty acids suitable for use in some embodiments described herein include methyl laurate, methyl myristate, methyl palmitate, methyl stearate, methyl palmitoleate, methyl oleate, methyl linoleate, methyl docosahexanoate, methyl ecosapentanoate, ethyl laurate, ethyl myristate, ethyl palmitate, ethyl stearate, ethyl palmitoleate, ethyl oleate, ethyl linoleate, ethyl docosahexanoate, ethyl ecosapentanoate, isopropyl laurate, isopropyl myristate, isopropyl palmitate, isopropyl stearate, isopropyl palmitoleate, isopropyl oleate, isopropyl linoleate, isopropyl docosahexanoate, isopropyl ecosapentanoate, butyl laurate, butyl myristate, butyl palmitate, butyl stearate, butyl palmitoleate, butyl oleate, butyl linoleate, butyl docosahexanoate, butyl ecosapentanoate, hexyl laurate, hexyl myristate, hexyl palmitate, hexyl stearate, hexyl palmitoleate, hexyl oleate, hexyl linoleate, hexyl docosahexanoate, and hexyl ecosapentanoate.

In some embodiments, a PCM comprises a fatty alcohol. Any fatty alcohol not inconsistent with the objectives of the present disclosure may be used. For instance, a fatty alcohol, in some embodiments, can have a C4 to C28 aliphatic hydrocarbon tail. Further, in some embodiments, the hydrocarbon tail is saturated. Alternatively, in other embodiments, the hydrocarbon tail is unsaturated. The hydrocarbon tail can also be branched or linear. Non limiting examples of fatty alcohols suitable for use in some embodiments described herein include capryl alcohol, pelargonic alcohol, capric alcohol, undecyl alcohol, lauryl alcohol, tridecyl alcohol, myristyl alcohol, pentadecyl alcohol, cetyl alcohol, heptadecyl alcohol, stearyl alcohol, nonadecyl alcohol, arachidyl alcohol, heneicosyl alcohol, behenyl alcohol, lignoceryl alcohol, ceryl alcohol, and montanyl alcohol. In some embodiments, a PCM comprises a combination, mixture, or plurality of differing fatty alcohols.

In some embodiments, a PCM comprises a fatty carbonate ester, sulfonate, or phosphonate. Any fatty carbonate ester, sulfonate, or phosphonate not inconsistent with the objectives of the present disclosure may be used. In some embodiments, a PCM comprises a C4 to C28 alkyl carbonate ester, sulfonate, or phosphonate. In some embodiments, a PCM comprises a C4 to C28 alkenyl carbonate ester, sulfonate, or phosphonate. In some embodiments, a PCM comprises a combination, mixture, or plurality of differing fatty carbonate esters, sulfonates, or phosphonates. In addition, a fatty carbonate ester described herein can have two alkyl or alkenyl groups described herein or only one alkyl or alkenyl group described herein.

Moreover, in some embodiments, a PCM comprises a paraffin. Any paraffin not inconsistent with the objectives of the present disclosure may be used. In some embodiments, a PCM comprises n-dodecane, n-tridecane, n-tetradecane, n-pentadecane, n-hexadecane, n-heptadecane, n-octadecane, n-nonadecane, n-eicosane, n-heneicosane, n-docosane, n-tricosane, n-tetracosane, n-pentacosane, n-hexacosane, n-heptacosane, n-octacosane, n-nonacosane, n-triacontane, n-hentriacontane, n-dotriacontane, n-tritriacontane, and/or mixtures thereof.

In addition, in some embodiments, a PCM comprises a polymeric material. Any polymeric material not inconsistent with the objectives of the present disclosure may be used. Non-limiting examples of suitable polymeric materials for use in some embodiments described herein include thermoplastic polymers (e.g., poly(vinyl ethyl ether), poly(vinyl n-butyl ether) and polychloroprene), polyethylene glycols (e.g., CARBOWAX® polyethylene glycol 400, CARBOWAX® polyethylene glycol 600, CARBOWAX® polyethylene glycol 1000, CARBOWAX® polyethylene glycol 1500, CARBOWAX® polyethylene glycol 4600, CARBOWAX® polyethylene glycol 8000, and CARBOWAX® polyethylene glycol 14,000), and polyolefins (e.g., lightly crosslinked polyethylene and/or high density polyethylene).

Additional non-limiting examples of phase change materials suitable for use in some embodiments described herein include BioPCM materials commercially available from Phase Change Energy Solutions (Asheboro, North Carolina), such as BioPCM®-(-8), BioPCM-(-6), BioPCM-(-4), BioPCM-(-2), BioPCM-4, BioPCM-6, BioPCM 08, BioPCM-Q12, BioPCM-Q15, BioPCM-Q18, BioPCM-Q20, BioPCM-Q21, BioPCM-Q23, BioPCM-Q25, BioPCM-Q27, BioPCM-Q30, BioPCM-Q32, BioPCM-Q35, BioPCM-Q37, BioPCM-Q42, BioPCM-Q49, BioPCM-55, BioPCM-60, BioPCM-62, BioPCM-65, BioPCM-69, and others.

It is further to be understood that a system described herein can comprise a plurality of differing PCMs, including differing PCMs of differing types. Any mixture or combination of differing PCMs not inconsistent with the objectives of the present disclosure may be used. In some embodiments, for example, system described herein comprises one or more fatty acids and one or more fatty alcohols. Further, as described above, a plurality of differing PCMs, in some cases, is selected based on a desired phase transition temperature and/or latent heat of the mixture of PCMs.

Moreover, in some cases, the PCM or combination or mixture of PCMs does not comprise ice, or does not consist essentially of ice, or does not consist of ice. That is, in some preferred embodiments, ice is not used as the PCM or thermal management material of a system or method described herein. It is to be understood that “ice” is water ice.

Further, in some embodiments, one or more properties of a PCM described herein can be modified by the inclusion of one or more additives. Such an additive described herein can be mixed with a PCM and/or disposed in a system described herein. In some embodiments, an additive comprises a thermal conductivity modulator. A thermal conductivity modulator, in some embodiments, increases the thermal conductivity of the PCM. In some embodiments, a thermal conductivity modulator comprises carbon, including graphitic carbon. In some embodiments, a thermal conductivity modulator comprises carbon black and/or carbon nanoparticles. Carbon nanoparticles, in some embodiments, comprise carbon nanotubes and/or fullerenes. In some embodiments, a thermal conductivity modulator comprises a graphitic matrix structure. In other embodiments, a thermal conductivity modulator comprises an ionic liquid. In some embodiments, a thermal conductivity modulator comprises a metal, including a pure metal or a combination, mixture, or alloy of metals. Any metal not inconsistent with the objectives of the present disclosure may be used. In some embodiments, a metal comprises a transition metal, such as silver or copper. In some embodiments, a metal comprises an element from Group 13 or Group 14 of the periodic table. In some embodiments, a metal comprises aluminum. In some embodiments, a thermal conductivity modulator comprises a metallic filler dispersed within a matrix formed by the PCM. In some embodiments, a thermal conductivity modulator comprises a metal matrix structure or cage-like structure, a metal tube, a metal plate, and/or metal shavings. Further, in some embodiments, a thermal conductivity modulator comprises a metal oxide. Any metal oxide not inconsistent with the objectives of the present disclosure may be used. In some embodiments, a metal oxide comprises a transition metal oxide. In some embodiments, a metal oxide comprises alumina.

In other embodiments, an additive comprises a nucleating agent. A nucleating agent, in some embodiments, can help avoid subcooling, particularly for PCMs comprising finely distributed phases, such as fatty alcohols, paraffinic alcohols, amines, and paraffins. Any nucleating agent not inconsistent with the objectives of the present disclosure may be used. In still other instances, an additive comprises a fire retardant or fire-resistant material, or a biocidal material.

### II. Food Delivery Charging Systems

In another aspect, temperature charging cradle systems 100, and food transportations systems are described herein to comprise a base unit 101 comprising a first temperature adjustment unit 112 generating a first temperature medium, hot air, and a second temperature adjustment unit 113 generating a second temperature medium, cold air. The temperature charging cradle 100 further comprises a vertically upwardly facing backing 102 affixed to the base unit 101, at least two fully enclosed channel ducts 103 and 104 affixed to the vertically upwardly facing backing 102, wherein the first temperature adjustment unit 112 is connected to one of the fully enclosed channel duct 103 and the second temperature adjustment unit 113 is connected to the fully enclosed channel duct 104 so that one fully enclosed channel duct 103 conveys the first temperature medium, hot air, from the first temperature adjustment unit 112 and the second fully enclosed channel duct 104 conveys the second temperature medium, cold air, from the second temperature adjustment unit 112.

The temperature charging cradle 100 further comprises at least one horizontal shelf 105 for holding a food storage system 200, the at least one horizontal shelf 105 generally extending perpendicular outwardly from the vertical upward facing backing 102 and affixed to the vertical upward facing backing 102 wherein the at least one horizontal shelf 105 comprises at least two shelf temperature medium portals 110 and 111 each individually connected to one of the at least two fully enclosed channel ducts 103 and 104 so that the first temperature medium, hot air, is conveyed from the fully enclosed channel duct 103 to the temperature medium portal 110 and the second temperature medium, cold air, is conveyed from the fully enclosed channel duct 104 to the temperature medium portal 111. The at least two shelf temperature medium portals 110 and 111 and the food transportation system, container or bag portals are electrically controlled valves, and the ports on the shelf can “snap into” the ports on the bag.

In another aspect, temperature charging cradle systems 100, and food transportations systems are described herein to comprise a food transportation system 200 positioned on the at least one horizontal shelf 105. The food transportation system 200 comprises phase change material disposed in the interior volume of the food transportation system 200, a first food storage compartment 210 and a second food storage compartment 211, each food storage compartment defined by a floor 212, one or more side walls 214, and a lid 216. The food transportation systems comprise two food storage portals so that the food transportation system portal 220 interconnects with the shelf temperature medium portal 110 so that the first temperature medium, hot air, is conveyed from the shelf portal 110 through the food storage portal storage portal to the phase change materials at the desired temperature. The food storage compartment portal 221 of the second food storage compartment interconnects with the shelf temperature medium portal 111 so that the second temperature medium, cold air, is conveyed from the shelf temperature medium portal 111 through the food storage portal storage portal to the phase change materials (“PCMs”) at the desired temperature.

In another aspect, temperature charging cradle systems 100, and food transportations systems are described herein to comprise a thermal insulation layer. A thermal insulation layer can be formed from any material not inconsistent with the objectives of the present disclosure. In some preferred embodiments, the thermal insulation layer is formed from a thermally insulating material such as a foam or fiberglass. Other thermally insulating materials may also be used. It is to be understood that such a thermal insulation layer is not particularly limited and can be used in the side walls of a fabric or other food delivery bag described herein or in or around ducts or other components of a charging cradle system described herein. Thermally insulating materials or layers may also advantageously be disposed between “hot” and “cold” food storage compartments of a bag described herein, or between any two storage compartments including PCMs having different phase transition temperatures.

In another aspect, temperature charging cradle systems 100, and food transportations systems are described herein to comprise a temperature charging cradle 100 comprising a base unit 101 comprising a first temperature adjustment unit 112 generating a first temperature medium, hot air, and a second temperature adjustment unit 113 generating a second temperature medium, cold air, a vertically upwardly facing backing 102 affixed to the base unit 101, at least two fully enclosed channel ducts 103 and 104 affixed to the vertically upwardly facing backing 102, wherein the first temperature adjustment unit 112 is connected to one of the fully enclosed channel duct 103 and the second temperature adjustment unit 113 is connected to the fully enclosed channel duct 104 so that one fully enclosed channel duct 103 conveys the first temperature medium, hot air, from the first temperature adjustment unit 112 and the second fully enclosed channel duct 104 conveys the second temperature medium, cold air, from the second temperature adjustment unit 112.

The temperature charging cradle 100 may further comprise a base unit 101 comprising a venting system to reduce temperature buildup in the base unit 101, and the at least one horizontal shelf 105 are cradle shaped wherein the at least one horizontal shelf 105 comprises a flat horizontal area 106, and upward directed ends 107 and 108 for proper alignment of the food transportation system 200.

The temperature charging cradle 100 may further comprise the first temperature adjustment unit 112 generates a medium, hot air, having a temperature of 50° C. or more, and the second temperature adjustment unit 113 generates a medium, cold air, having a temperature of 15° C. or less, and the vertically upwardly facing backing 102 and the at least one horizontal shelf 105 are segmented modular units 105a, 105b wherein each segmented modular unit 105a, 105b comprises enclosed channel ducts 103 and 104 affixed to the vertically upwardly facing backing 102 and said at least one horizontal shelf 105, and wherein the enclosed channel ducts 103 and 104 further comprise a cap 103a and 104b to seal each enclosed channel duct 103 and 104.

The temperature charging cradle 100 may further comprise a thermal status indicator 20 indicating a visual or auditory indication related to the temperature status of the food transportation system 200.

### III. Food Transportation Systems Containers or Bags

In another aspect, food transportation systems, containers or bags 200 are described herein to comprise a phase change material disposed in the interior volume of the food transportation system 200 and a first food storage compartment 211 and a second food storage compartment 212, each food storage compartment defined by a floor 212, one or more side walls 214, and a lid 216. In some embodiments (but not all embodiments, as contemplated above in Section I), each food storage compartment further comprises a food storage portal so that the food storage portal 220 of the first food storage compartment interconnects with a shelf temperature medium portal 110 so that a first temperature medium, hot air, is conveyed from the shelf portal 110 through the food storage portal into the phase change material area thereby charging the phase change materials at the desired temperature for the hot food compartment. The food storage compartment portal 221 of a second food storage compartment interconnects with the shelf temperature medium portal 111 so that the second temperature medium, cold air, is conveyed from the shelf temperature medium portal 111 through the food storage portal into the phase change material area thereby charging the phase change materials at the desired temperature for the cold compartment.

The food transportation systems 200 may further comprise at least two food storage interior compartments the two separated temperature control spaces 201, 202 include a hot space 202 and a cold space 201, defined by a floor, one or more side walls, and a hinged lid, and, optionally, one or more phase change materials having a phase transition temperature corresponding to a desired delivery temperature of the food; optionally, one or more thermally insulating materials disposed in, or forming interior or exterior walls of, the one or more food storage compartments; optionally, an indicator light for showing the status of a phase change material in a charged or uncharged state; optionally, a magnetic closure for the food storage compartment, including, optionally, a positive closure mechanism; optionally, one or more additional food storage compartments and/or one or more additional phase change materials for storing and/or transporting a food at a temperature different from the desired delivery temperature.

The food transportation systems 200 wherein the first food storage compartment 211 is a hot compartment and the second food storage compartment 212 is a cold compartment, the first temperature adjustment unit 112 generates a medium having a temperature of 50° C. or more, and the second temperature adjustment unit 113 generates a medium having a temperature of 15° C. or less.

The food transportation systems 200 wherein the first food storage compartment 211 is a hot compartment 211a and is sized to from 50% to 90% of the size of the total compartment and the second food storage compartment 212 is a cold compartment and is sized to from 10% to 50% of the size of the size of the total compartment; and wherein the lid 216 comprises two center-hinged lids 216a and 216b wherein the center-lid 216a covers the hot compartment 211a and the center-lid 216b covers the cold compartment 211b.

The food transportation systems 200 wherein the first food storage compartment 211 is a hot compartment 211a and is sized to from 70% to 80% of the size of the total compartment and the second food storage compartment 212 is a cold compartment and is sized to from 20% to 30% of the size of the size of the total compartment; and wherein the lid 216 comprises two center-hinged lids 216a and 216b wherein the center-lid 216a covers the hot compartment 211a and the center-lid 216b covers the cold compartment 211b, the food transportation system 200 further comprises one or more phase change materials having a phase transition temperature corresponding to a desired delivery temperature of the food; and one or more thermally insulating materials disposed in, or forming interior or exterior walls of, the one or more food storage compartments.

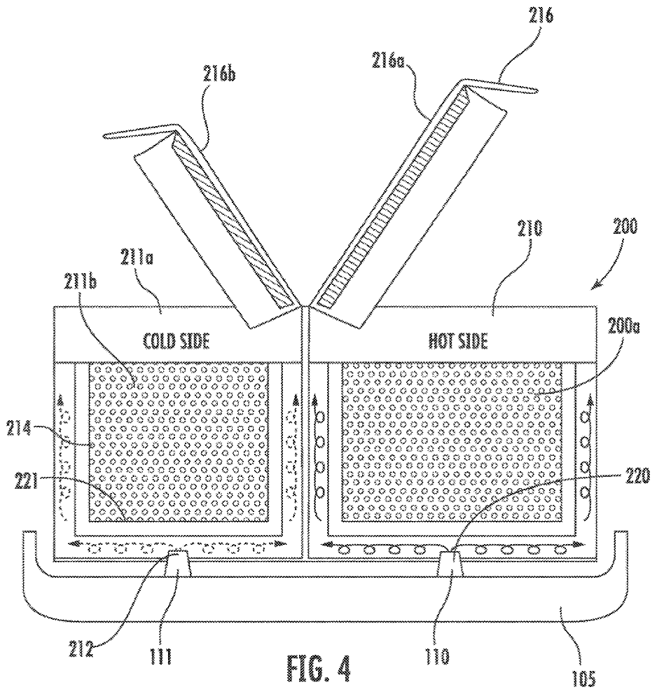

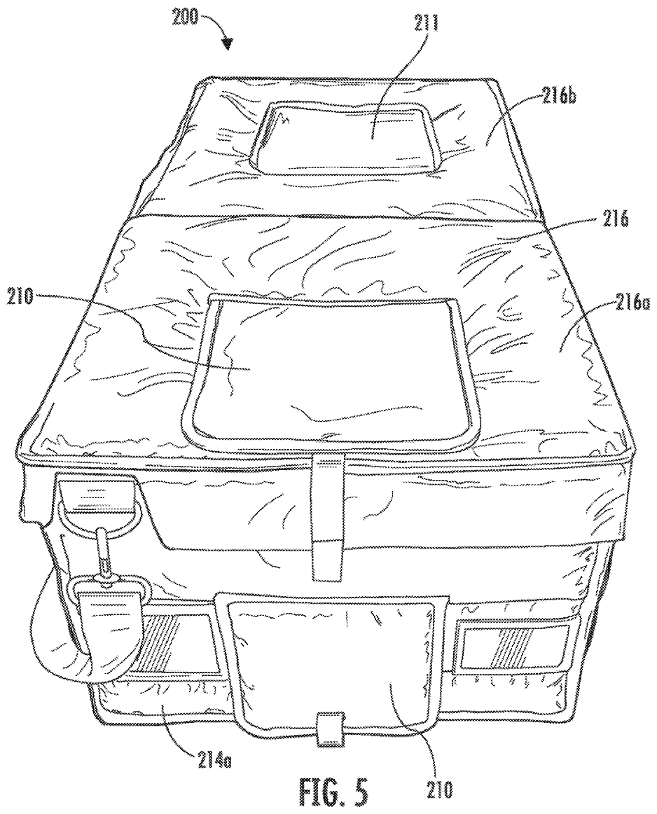

In one aspect, food transportation systems are described herein, with reference to FIGS. 4-10. In some embodiments, food transportation systems described herein can be in the form of a container or bag. As generally shown in at least FIGS. 4-10, a food transportation system 200 described herein comprises two interior compartments, cavities or receiving spaces generally called first food storage compartment 210 and second food storage compartment 211, each compartment defined by a floor 212 and one or more side walls 214a-214d. In some cases, the food transportation system comprises a lid 216 having a closed configuration and an open configuration. In the closed configuration, a bottom surface of lid 216 is in facing opposition to floor 212, as depicted for example, in at least FIGS. 5-8.

Side walls 214 described herein can be formed from any material not inconsistent with the objectives of this disclosure. In some embodiments, the side walls are formed from a fabric. For example, in some cases, the side walls are formed from a polyester, polyolefin, or polyamide (such as nylon) fabric. The fabric can be a woven or non-woven fabric. The side walls of a system described herein can also be formed from a combination of differing materials. For example, in some cases, the side walls comprise or are formed from an exterior fabric layer, an interior fabric or plastic layer, and, optionally, an intermediate foam layer. In some such embodiments, the exterior fabric layer is the layer closest to or facing the exterior environment of the system and comprises or is formed from a polyester fabric. The interior fabric or plastic layer is the layer closest to or facing the interior compartment or receiving space, and comprises or is formed from a nylon. The intermediate foam layer can be disposed in between the interior and exterior layers as an intermediate layer and can comprise thermally insulating foam such as a polyethylene or polyurethane foam. An intermediate structural layer can also be provided for structural support of the side walls and/or of weight placed on the top of the system or container, such as may occur when a plurality of systems described herein are stacked on top of one another. For instance, in some embodiments, a cardboard or corrugated material such as a corrugated plastic is disposed within one or more of the side walls as an intermediate structural layer, such as between the exterior and interior layers.

Systems described herein can have any three-dimensional shape not inconsistent with the objectives of this disclosure. In some preferred embodiments, a system described herein has a “box-shaped” or rectangular prism-shaped interior volume, defined in part by four side walls, each forming a 90-degree angle with two other side walls, such as is shown.

As shown in at least FIGS. 4-10, an exemplary food transportation system 200 comprises two food compartments 210, 211 each defined by four orthogonal side walls 214a-214d. A first side wall 214a and second side wall 214b of the four orthogonal side walls are opposite to one another. A third side wall 214c and a fourth side wall 214d of the four orthogonal side walls are also opposite to one another.

In some embodiments, a system 200 described herein can have at least one opening or lid 216 for each compartment 210, 211, wherein the lid is a center hinged lid including 216a and 216b and shown in FIGS. 4, 9, 10. The lid 216a, 216b, opening provides access to the food compartment 210, 211 from an exterior environment of the food transportation system 200. FIGS. 4, 9, 10 show an exemplary opening 215 formed in lid 216a and 216b. In systems having a shelf positioned in the interior volume and dividing the interior volume into two separated receiving spaces, the system can have a first opening in the side wall allowing access to one of the two separated receiving spaces and a second opening in the side wall or lid allowing access to the other of the two separated receiving spaces as shown in FIG. 4 for example.

Systems 200 described herein can further comprise one or more covers or doors disposed on an exterior surface. The cover is positioned adjacent to the opening of the interior compartment. In some cases, the lid 216 is centerly hingedly connected to the exterior surface of the system 200. The cover can have the same construction as the side walls, such as an exterior fabric layer, an interior fabric or plastic layer, and, optionally, an intermediate foam layer. FIGS. 1-3 show two exemplary lids 216 in a closed position, where lids 216 extend across an opening in side wall 214a. FIGS. 4, 9, 10 show embodiments where lid 216 is in an open position. FIGS. 4, 9, 10 specifically shows an embodiment where lids 216a, 216b are both in an open position, providing access to opening 215.

### IV. Use of the Food Delivery Temperature Charging Systems Temperature Charging Cradle Systems or Food Transportation Systems

In another aspect, the food delivery temperature charging systems, temperature charging cradle systems or food transportation systems as described as described further hereinbelow can be used in portable devices and fixed devices wherein the portable devices include delivery vehicles, aircraft including commercial, military, private and transportation aircraft, transportation trucks, water ships including passenger and freighter ships, trains, and fixed devices including restaurants, hotels and hotel rooms, entertainment locations, educational facilities, offices, and homes.

### V. Embodiments

The following embodiments describe various alternative aspects of charging systems and methods of using such systems. The following should not be construed as limiting, but, rather, a description of a variety of configurations and methods within the scope of the invention. Embodiment 1. A food delivery temperature charging system 1 for charging a food transportation system 200, said food delivery temperature charging system 1 comprising: a temperature charging cradle system 100 comprising a base unit 101 comprising a first temperature adjustment unit 112 generating a first temperature medium, hot air, a vertically upwardly facing backing 102 affixed to the base unit 101, at least one fully enclosed channel duct 103 affixed to the vertically upwardly facing backing 102, wherein the first temperature adjustment unit 112 is connected to said fully enclosed channel duct 103 so that the one fully enclosed channel duct 103 permits free flow of the first temperature medium to a charging station 120, the charging station 120 comprising at least one horizontal shelf 105 for holding a food storage system 200, the at least one horizontal shelf generally extending perpendicular outwardly from the vertical upward facing backing 102 and affixed to the vertical upward facing backing 102 wherein said at least one horizontal shelf 105 comprises at least one shelf temperature medium portal 110 wherein the shelf temperature medium portal 110 is connected to the at least one fully enclosed channel duct 103 so that the first temperature medium is conveyed from the fully enclosed channel duct 103 to the temperature medium portal 110; and a food transportation system 200 positioned on the at least one horizontal shelf 105 wherein the food transportation system 200 comprises phase change material disposed in the interior volume of the food transportation system 200 and a food storage compartment 210, the food storage compartment 210 defined by a floor 212, one or more side walls 214, and a lid 216, and a food storage compartment portal 220 that connects with the shelf temperature medium portal 110 so the first temperature medium is conveyed from the shelf temperature medium portal 110 through the food storage compartment portal into the food transportation system 200 charging the phase change materials at the desired temperature.

Embodiment 2. The food delivery temperature charging system 1 according to Embodiment 1 comprising: a temperature charging cradle 100 comprising a base unit 101 comprising a first temperature adjustment unit 112 generating a first temperature medium and a second temperature adjustment unit 113 generating a second temperature medium, a vertically upwardly facing backing 102 affixed to the base unit 101, at least two fully enclosed channel ducts 103 and 104 affixed to the vertically upwardly facing backing 102, wherein the first temperature adjustment unit 112 is connected to one of the fully enclosed channel duct 103 and the second temperature adjustment unit 113 is connected to the fully enclosed channel duct 104 so that one fully enclosed channel duct 103 conveys the first temperature medium from the first temperature adjustment unit 112 and the second fully enclosed channel duct 104 conveys the second temperature medium second temperature adjustment unit 112, the charging station 120 comprising at least one horizontal shelf 105 for holding a food storage system 200, the at least one horizontal shelf 105 generally extending perpendicular outwardly from the vertical upward facing backing 102 and affixed to the vertical upward facing backing 102 wherein the at least one horizontal shelf 105 comprises at least two shelf temperature medium portals 110 and 111 each individually connected to one of the at least two fully enclosed channel ducts 103 and 104 so that the first temperature medium is conveyed from the fully enclosed channel duct 103 to the temperature medium portal 110 and the second temperature medium is conveyed from the fully enclosed channel duct 104 to the temperature medium portal 111, and a food transportation system 200 positioned on the at least one horizontal shelf 105 wherein the food transportation system 200 comprises phase change material disposed in the interior volume of the food transportation system 200 and a first food storage compartment 211 and a second food storage compartment 212, each food storage compartment defined by a floor 213, one or more side walls 214, and a lid 216, and each food storage compartment comprises a food storage compartment portal so that the food storage compartment portal 220 of the first food storage compartment interconnects with the shelf temperature medium portal 110 so that the first temperature medium is conveyed from the shelf portal 110 through the food storage compartment portal into the first food storage compartment charging the phase change materials at the desired temperature, and food storage compartment portal 221 of the second food storage compartment interconnects with the shelf temperature medium portal 111 so that the second temperature medium is conveyed from the shelf temperature medium portal 111 through the food storage compartment portal into the second food storage compartment charging the phase change materials at the desired temperature.

Embodiment 3. The food delivery temperature charging system according to Embodiment 1 or 2, wherein the base unit 101 comprises a venting system to reduce temperature buildup in the base unit 101, and the at least one horizontal shelf 105 are cradle shaped wherein the at least one horizontal shelf 105 comprises a flat horizontal area 106, and upward directed ends 107 and 108 for proper alignment of the food transportation system 200.

Embodiment 4. The food delivery temperature charging system according to Embodiment 2 or 3, wherein the first food storage compartment 210 is a hot compartment and the second food storage compartment 211 is a cold compartment, the first temperature adjustment unit 112 generates a medium having a temperature of 50° C. or more, and the second temperature adjustment unit 113 generates a medium having a temperature of 15° C. or less, and the vertically upwardly facing backing 102 and the at least one horizontal shelf 105 are segmented modular units 105(a), 105(b) wherein each segmented modular unit 105(a), 105(b) comprises enclosed channel ducts 103 and 104 affixed to the vertically upwardly facing backing 102 and said at least one horizontal shelf 105, and wherein the enclosed channel ducts 103 and 104 further comprise a cap 103a and 104b to seal each enclosed channel duct 103 and 104.

Embodiment 5. The food delivery temperature charging system according to any of the preceding Embodiments, wherein the first temperature medium and the second temperature medium is air, wherein cool air and hot air is conveyed from the first temperature adjustment unit 112 and the a first temperature adjustment unit 113 to the first food storage compartment 211 and the second food storage compartment 212 of the food transportation system 200.

Embodiment 6. The food delivery temperature charging system according to any of the preceding Embodiments, wherein the first food storage compartment 210 is a hot compartment 210a and is sized to from 50% to 90% of the size of the total compartment and the second food storage compartment 211 is a cold compartment 211a and is sized to from 10% to 50% of the size of the size of the total compartment; and wherein the lid 216 comprises two center-hinged lids 216a and 216b wherein the center-lid 216a covers the hot compartment 211a and the center-lid 216b covers the cold compartment 211b.

Embodiment 7. The food delivery temperature charging system according to any of the preceding Embodiments, further comprising a thermal status indicator 20 indicating a visual or auditory indication related to the temperature status of the food transportation system 200, and the wherein the of the side walls, and the food transportation system 200 comprising a thermal status indicator 230 indicating a visual or auditory indication related to the temperature status of the food transportation system 200.

Embodiment 8. The food delivery temperature charging system according to any of the preceding Embodiments, wherein the food transportation system 200 comprises one or more phase change materials having a phase transition temperature corresponding to a desired delivery temperature of the food; one or more thermally insulating materials disposed in, or forming interior or exterior walls of, the one or more food storage compartments; an indicator light for showing the status of a phase change material in a charged or uncharged state; a magnetic closure for the food storage compartment, including, optionally, a positive closure mechanism; one or more additional food storage compartments and/or one or more additional phase change materials for storing and/or transporting a food at a temperature different from the desired delivery temperature; and one or more security and/or monitoring hardware and/or software items, including, optionally for controlling and/or monitoring the opening and closing of a food storage compartment.

Embodiment 9. The food delivery temperature charging system according to any of the preceding Embodiments, wherein the interior volume of each food storage compartment 211, 212 is defined by four orthogonal side walls; two of the four orthogonal side walls, opposite to one another, are formed from a relatively non-rigid material; the other two of the four orthogonal side walls, also opposite to one another, are formed from a relatively rigid material; the side walls formed from the relatively rigid material are attached to the side walls from the relatively non-rigid material only at the top of the side walls; the side walls formed from the relatively rigid material are configured to flip upwardly and downwardly to decrease or increase, respectively, the overall rigidity of the interior volume.

Embodiment 10. A temperature charging cradle 100 comprising: a temperature charging cradle system 100 comprising a base unit 101 comprising a first temperature adjustment unit 112 generating a first temperature medium, a vertically upwardly facing backing 102 affixed to the base unit 101, at least one fully enclosed channel duct 103 affixed to the vertically upwardly facing backing 102, wherein the first temperature adjustment unit 112 is connected to said fully enclosed channel duct 103 so that the one fully enclosed channel duct 103 permits free flow of the first temperature medium to a charging station 120, and the charging station 120 comprising at least one horizontal shelf 105 for holding a food storage system 200, the at least one horizontal shelf generally extending perpendicular outwardly from the vertical upward facing backing 102 and affixed to the vertical upward facing backing 102 wherein said at least one horizontal shelf 105 comprises at least one shelf temperature medium portal 110 wherein the shelf temperature medium portal 110 is connected to the at least one fully enclosed channel duct 103 so that the first temperature medium is conveyed from the fully enclosed channel duct 103 to the temperature medium portal 110.

Embodiment 11. A temperature charging cradle 100 according to Embodiment 10 comprising: a temperature charging cradle 100 comprising a base unit 101 comprising a first temperature adjustment unit 112 generating a first temperature medium and a second temperature adjustment unit 113 generating a second temperature medium, a vertically upwardly facing backing 102 affixed to the base unit 101, at least two fully enclosed channel ducts 103 and 104 affixed to the vertically upwardly facing backing 102, wherein the first temperature adjustment unit 112 is connected to one of the fully enclosed channel duct 103 and the second temperature adjustment unit 113 is connected to the fully enclosed channel duct 104 so that one fully enclosed channel duct 103 conveys the first temperature medium from the first temperature adjustment unit 112 and the second fully enclosed channel duct 104 conveys the second temperature medium second temperature adjustment unit 112, and the charging station 120 comprising at least one horizontal shelf 105 for holding a food storage system 200, the at least one horizontal shelf 105 generally extending perpendicular outwardly from the vertical upward facing backing 102 and affixed to the vertical upward facing backing 102 wherein the at least one horizontal shelf 105 comprises at least two shelf temperature medium portals 110 and 111 each individually connected to one of the at least two fully enclosed channel ducts 103 and 104 so that the first temperature medium is conveyed from the fully enclosed channel duct 103 to the temperature medium portal 110 and the second temperature medium is conveyed from the fully enclosed channel duct 104 to the temperature medium portal 111.

Embodiment 12. The temperature charging cradle 100 according to Embodiment 10 or 11, wherein the base unit 101 comprises a venting system to reduce temperature buildup in the base unit 101, and the at least one horizontal shelf 105 are cradle shaped wherein the at least one horizontal shelf 105 comprises a flat horizontal area 106, and upward directed ends 107 and 108 for proper alignment of a food transportation system 200.

Embodiment 13. The temperature charging cradle 100 according to any of Embodiments 10 to 12, wherein the first temperature adjustment unit 112 generates a medium having a temperature of 50° C. or more, and the second temperature adjustment unit 113 generates a medium having a temperature of 15° C. or less, and the vertically upwardly facing backing 102 and the at least one horizontal shelf 105 are segmented modular units 105a, 105b wherein each segmented modular unit 105a, 105b comprises enclosed channel ducts 103 and 104 affixed to the vertically upwardly facing backing 102 and said at least one horizontal shelf 105, and wherein the enclosed channel ducts 103 and 104 further comprise a cap 103a and 104b to seal each enclosed channel duct 103 and 104.

Embodiment 14. The temperature charging cradle 100 according to Embodiment 10 to 13, further comprising a thermal status indicator 20 indicating a visual or auditory indication related to the temperature status of the food transportation system 200, and the wherein the of the side walls.

Embodiment 15. A food transportation system 200 comprising a phase change material disposed in the interior volume of the food transportation system 200 and a first food storage compartment 210 and a second food storage compartment 211, each food storage compartment defined by a floor 212, one or more side walls 214, and a lid 216, and each food storage compartment 210, 211, comprises a food storage compartment portal 220, 221, so that the food storage compartment portal 220 of the first food storage compartment interconnects with a shelf temperature medium portal 110 so that a first temperature medium is conveyed from the shelf portal 110 through the food storage compartment portal into the first food storage compartment charging the phase change materials at the desired temperature, and food storage compartment portal 221 of a second food storage compartment interconnects with the shelf temperature medium portal 111 so that the second temperature medium is conveyed from the shelf temperature medium portal 111 through the food storage compartment portal into the second food storage compartment charging the phase change materials at the desired temperature.

Embodiment 16. A food transportation system 200 according to Embodiment 15 comprising at least two food storage compartments 210, 211, the two food storage compartments 210, 211 include a hot compartment 210a and a cold compartment 211b, defined by a floor 212, one or more side walls 214, and a lid 216; optionally, one or more phase change materials having a phase transition temperature corresponding to a desired delivery temperature of the food; optionally, one or more thermally insulating materials disposed in, or forming interior or exterior walls of, the one or more food storage compartments; optionally, an indicator light for showing the status of a phase change material in a charged or uncharged state; optionally, a magnetic closure for the food storage compartment, including, optionally, a positive closure mechanism; optionally, one or more additional food storage compartments and/or one or more additional phase change materials for storing and/or transporting a food at a temperature different from the desired delivery temperature; optionally, one or more security and/or monitoring hardware and/or software items, including, optionally for controlling and/or monitoring the opening and closing of a food storage compartment.

Embodiment 17. The food transportation system 200 according to any of Embodiments 15 or 16 the first food storage compartment 210 is a hot compartment 210a and the second food storage compartment 211 is a cold compartment 211b, the first temperature adjustment unit 112 generates a medium having a temperature of 50° C. or more, and the second temperature adjustment unit 113 generates a medium having a temperature of 15° C. or less.

Embodiment 18. The food transportation system 200 according to any of Embodiments 15 or 17, wherein the first temperature medium and the second temperature medium is air wherein cool air and hot air is conveyed from the first temperature adjustment unit 112 and the a first temperature adjustment unit 113 to the first food storage compartment 210 and the second food storage compartment 211 of the a food transportation system 200.

Embodiment 19. The food transportation system 200 according to any of Embodiments 15 to 18, wherein the first food storage compartment 210 is a hot compartment 210a and is sized to from 50% to 90% of the size of the total compartment and the second food storage compartment 211 is a cold compartment 211b and is sized to from 10% to 50% of the size of the size of the total compartment; and wherein the lid 216 comprises two center-hinged lids 216a and 216b wherein the center-lid 216a covers the hot compartment 210a and the center-lid 216b covers the cold compartment 211b.

Embodiment 20. The food transportation system 200 according to any of Embodiments 15 to 19, wherein the first food storage compartment 210 is a hot compartment 210a and is sized to from 70% to 80% of the size of the total compartment and the second food storage compartment 211 is a cold compartment 211b and is sized to from 20% to 30% of the size of the size of the total compartment; and wherein the lid 216 comprises two center-hinged lids 216a and 216b wherein the center-lid 216a covers the hot compartment 211a and the center-lid 216b covers the cold compartment 211b, the food transportation system 200 further comprises one or more phase change materials having a phase transition temperature corresponding to a desired delivery temperature of the food; one or more thermally insulating materials disposed in, or forming interior or exterior walls of, the one or more food storage compartments; an indicator light for showing the status of a phase change material in a charged or uncharged state; a magnetic closure for the food storage compartment, including, optionally, a positive closure mechanism; one or more additional food storage compartments and/or one or more additional phase change materials for storing and/or transporting a food at a temperature different from the desired delivery temperature; and/or one or more security and/or monitoring hardware and/or software items, including, optionally for controlling and/or monitoring the opening and closing of a food storage compartment.

Embodiment 21. Use of the food delivery temperature charging system 1, temperature charging cradle system 100 or food transportation system 200 of any of the preceding Embodiments in portable devices and fixed devices wherein the portable devices include delivery vehicles, aircraft including commercial, military, private and transportation aircraft, transportation trucks, water ships including passenger and freighter ships, trains, and fixed devices including restaurants, hotels and hotel rooms, entertainment locations, educational facilities, offices, and homes.

Embodiment 22. A device including portable and fixed devices comprising the food delivery temperature charging system 1, temperature charging cradle system 100 or food transportation system 200 of any of the preceding Embodiments wherein the portable devices include delivery vehicles, aircraft including commercial, military, private and transportation aircraft, transportation trucks, water ships including passenger and freighter ships, trains, and fixed devices including restaurants, hotels and hotel rooms, entertainment locations, educational facilities, offices, and homes.

Various implementations of apparatus and methods have been described in fulfillment of the various objectives of the present disclosure. It should be recognized that these implementations are merely illustrative of the principles of the present disclosure. Numerous modifications and adaptations thereof will be readily apparent to those skilled in the art without departing from the spirit and scope of the present disclosure. For example, individual steps of methods described herein can be carried out in any manner and/or in any order not inconsistent with the objectives of the present disclosure, and various configurations or adaptations of apparatus described herein may be used.

What is claimed is:

1. A food delivery temperature charging system for charging a food transportation system, said food delivery temperature charging system comprising: a temperature charging cradle system comprising a base unit comprising a first temperature adjustment unit generating a first temperature medium, hot air, a vertically upwardly facing backing affixed to the base unit, at least one fully enclosed channel duct affixed to the vertically upwardly facing backing, wherein the first temperature adjustment unit is connected to said fully enclosed channel duct so that the one fully enclosed channel duct permits free flow of the first temperature medium to a charging station, the charging station comprising at least one horizontal shelf for holding a food storage system, the at least one horizontal shelf generally extending perpendicular outwardly from the vertical upward facing backing and affixed to the vertical upward facing backing wherein said at least one horizontal shelf comprises at least one shelf temperature medium portal wherein the shelf temperature medium portal is connected to the at least one fully enclosed channel duct so that the first temperature medium is conveyed from the fully enclosed channel duct to the temperature medium portal; and a food transportation system positioned on the at least one horizontal shelf wherein the food transportation system comprises phase change material disposed in the interior volume of the food transportation system and a food storage compartment, the food storage compartment defined by a floor, one or more side walls, and a lid, and a food storage compartment portal that connects with the shelf temperature medium portal so the first temperature medium is conveyed from the shelf temperature medium portal through the food storage compartment portal into the food transportation system charging the phase change materials at the desired temperature.

2. The food delivery temperature charging system according to claim 1, wherein temperature charging cradle comprising base unit comprises a first temperature adjustment unit generating a first temperature medium and a second temperature adjustment unit generating a second temperature medium.

3. The food delivery temperature charging system according to claim 2 comprising: at least two fully enclosed channel ducts affixed to the vertically upwardly facing backing, wherein the first temperature adjustment unit is connected to one of the fully enclosed channel duct and the second temperature adjustment unit is connected to the fully enclosed channel duct so that one fully enclosed channel duct conveys the first temperature medium from the first temperature adjustment unit and the second fully enclosed channel duct conveys the second temperature medium second temperature adjustment unit.

4. The food delivery temperature charging system according to claim 3, wherein the at least one horizontal shelf comprises at least two shelf temperature medium portals and each individually connected to one of the at least two fully enclosed channel ducts and so that the first temperature medium is conveyed from the fully enclosed channel duct to the temperature medium portal and the second temperature medium is conveyed from the fully enclosed channel duct to the temperature medium portal.

5. The food delivery temperature charging system according to claim 4, wherein the food transportation system comprises phase change material disposed in the interior volume of the food transportation system and a first food storage compartment and a second food storage compartment, each food storage compartment defined by a floor, one or more side walls, and a lid.

6. The food delivery temperature charging system according to claim 5, wherein each food storage compartment comprises a food storage compartment portal so that the food storage compartment portal of the first food storage compartment interconnects with the shelf temperature medium portal so that the first temperature medium is conveyed from the shelf portal through the food storage compartment portal into the first food storage compartment charging the phase change materials at the desired temperature, and food storage compartment portal of the second food storage compartment interconnects with the shelf temperature medium portal so that the second temperature medium is conveyed from the shelf temperature medium portal through the food storage compartment portal into the second food storage compartment charging the phase change materials at the desired temperature.

7. The food delivery temperature charging system according to claim 1, wherein the base unit comprises a venting system to reduce temperature buildup in the base unit, and the at least one horizontal shelf are cradle shaped wherein the at least one horizontal shelf comprises a flat horizontal area, and upward directed ends for proper alignment of the food transportation system.

8. The food delivery temperature charging system according to claim 7, wherein the first food storage compartment is a hot compartment and the second food storage compartment is a cold compartment, optionally, the first temperature adjustment unit generates a medium having a temperature of 50°C or more, and the second temperature adjustment unit generates a medium having a temperature of 15°C or less, and optionally, the vertically upwardly facing backing and the at least one horizontal shelf are segmented modular units wherein each segmented modular unit comprises enclosed channel ducts and affixed to the vertically upwardly facing backing and said at least one horizontal shelf, and wherein the enclosed channel ducts further comprise a cap to seal each enclosed channel duct.

9. The food delivery temperature charging system according to according to claim 7, wherein the first temperature medium and the second temperature medium is air, wherein cool air and hot air is conveyed from the first temperature adjustment unit and the a first temperature adjustment unit to the first food storage compartment and the second food storage compartment of the a food transportation system.

10. The food delivery temperature charging system according to according to claim 7, wherein the first food storage compartment is a hot compartment and is sized to from 50% to 90% of the size of the total compartment and the second food storage compartment is a cold compartment and is sized to from 10% to 50% of the size of the size of the total compartment; and wherein the lid comprises two center-hinged lids wherein one center-lid covers the hot compartment and one center-lid covers the cold compartment.

11. The food delivery temperature charging system according to claim 1, further comprising a thermal status indicator indicating a visual or auditory indication related to the temperature status of the food transportation system, and the wherein the of the side walls, and the food transportation system comprising a thermal status indicator indicating a visual or auditory indication related to the temperature status of the food transportation system.

12. The food delivery temperature charging system according to claim 1, wherein the food transportation system comprises one or more of: a phase change material having a phase transition temperature corresponding to a desired delivery temperature of the food; a thermally insulating material disposed in, or forming interior or exterior walls of, the one or more food storage compartments; an indicator light for showing the status of a phase change material in a charged or uncharged state; a magnetic closure for the food storage compartment, including, optionally, a positive closure mechanism; one or more additional food storage compartments and/or one or more additional phase change materials for storing and/or transporting a food at a temperature different from the desired delivery temperature; and/or one or more security and/or monitoring hardware and/or software items, including, optionally for controlling and/or monitoring the opening and closing of a food storage compartment.

13. The food delivery temperature charging system according to claim 1, wherein the interior volume of each food storage compartment, is defined by four orthogonal side walls; two of the four orthogonal side walls, opposite to one another, are formed from a relatively non-rigid material; the other two of the four orthogonal side walls, also opposite to one another, are formed from a relatively rigid material; the side walls formed from the relatively rigid material are attached to the side walls from the relatively non-rigid material only at the top of the side walls; and/or the side walls formed from the relatively rigid material are configured to flip upwardly and downwardly to decrease or increase, respectively, the overall rigidity of the interior volume.

14. A temperature charging cradle comprising: a temperature charging cradle system comprising a base unit comprising a first temperature adjustment unit generating a first temperature medium, a vertically upwardly facing backing affixed to the base unit, at least one fully enclosed channel duct affixed to the vertically upwardly facing backing, wherein the first temperature adjustment unit is connected to said fully enclosed channel duct so that the one fully enclosed channel duct permits free flow of the first temperature medium to a charging station, and the charging station comprising at least one horizontal shelf for holding a food storage system, the at least one horizontal shelf generally extending perpendicular outwardly from the vertical upward facing backing and affixed to the vertical upward facing backing wherein said at least one horizontal shelf comprises at least one shelf temperature medium portal wherein the shelf temperature medium portal is connected to the at least one fully enclosed channel duct so that the first temperature medium is conveyed from the fully enclosed channel duct to the temperature medium portal.

15. A temperature charging cradle according to claim 14, wherein the base unit comprises the first temperature adjustment unit generating a first temperature medium and a second temperature adjustment unit generating a second temperature medium.

16. The temperature charging cradle according to claim 15, wherein at least two fully enclosed channel ducts and are affixed to the vertically upwardly facing backing, the first temperature adjustment unit is connected to one of the fully enclosed channel ducts and the second temperature adjustment unit is connected to the other fully enclosed channel duct so that one fully enclosed channel duct conveys the first temperature medium from the first temperature adjustment unit and the other fully enclosed channel duct conveys the second temperature medium second temperature adjustment unit.

17. The temperature charging cradle according to claim 16, wherein the at least one horizontal shelf comprises at least two shelf temperature medium portals and each individually connected to one of the at least two fully enclosed channel ducts and so that the first temperature medium is conveyed from the fully enclosed channel duct to the temperature medium portal and the second temperature medium is conveyed from the fully enclosed channel duct to the temperature medium portal.

18. The temperature charging cradle according to according to claim 14, wherein the base unit comprises a venting system to reduce temperature buildup in the base unit.

19. The temperature charging cradle according to claim 14, wherein the at least one horizontal shelf is cradle shaped, and wherein the at least one horizontal shelf comprises a flat horizontal area, and upward directed ends for proper alignment of a food transportation system.

20. The temperature charging cradle according to claim 15, wherein the first temperature adjustment unit generates a medium having a temperature of 50° C. or more, and the second temperature adjustment unit generates a medium having a temperature of 15° C. or less.

21. The temperature charging cradle according to claim 14, wherein the vertically upwardly facing backing and the at least one horizontal shelf are segmented modular units wherein each segmented modular unit comprises enclosed channel ducts and affixed to the vertically upwardly facing backing and said at least one horizontal shelf, and wherein the enclosed channel ducts and further comprise a cap to seal each enclosed channel duct.

22. The temperature charging cradle according to claim 14 further comprising: a thermal status indicator indicating a visual or auditory indication related to the temperature status of the food transportation system.

23. A food transportation system comprising a phase change material disposed in the interior volume of the food transportation system and a first food storage compartment and a second food storage compartment, each food storage compartment defined by a floor, one or more side walls, and a lid, and each food storage compartment, comprises a food storage compartment portal,, so that the food storage compartment portal of the first food storage compartment interconnects with a shelf temperature medium portal so that a first temperature medium is conveyed from the shelf portal through the food storage compartment portal into the first food storage compartment charging the phase change materials at the desired temperature, and food storage compartment portal of a second food storage compartment interconnects with the shelf temperature medium portal so that the second temperature medium is conveyed from the shelf temperature medium portal through the food storage compartment portal into the second food storage compartment charging the phase change materials at the desired temperature.

24. A food transportation system according to claim 23 further comprising: at least two food storage compartments, the two food storage compartments, include a hot compartment and a cold compartment, defined by a floor, one or more side walls, and a lid; optionally, one or more phase change materials having a phase transition temperature corresponding to a desired delivery temperature of the food; optionally, one or more thermally insulating materials disposed in, or forming interior or exterior walls of, the one or more food storage compartments; optionally, an indicator light for showing the status of a phase change material in a charged or uncharged state;
optionally, a magnetic closure for the food storage compartment, including, optionally, a positive closure mechanism; optionally, one or more additional food storage compartments and/or one or more additional phase change materials for storing and/or transporting a food at a temperature different from the desired delivery temperature; and optionally, one or more security and/or monitoring hardware and/or software items, including, optionally for controlling and/or monitoring the opening and closing of a food storage compartment.

25. The food transportation system according to any of claims 23 or 24, wherein the first food storage compartment is a hot compartment and the second food storage compartment is a cold compartment, and the first temperature adjustment unit generates a medium having a temperature of 50° C. or more, and the second temperature adjustment unit generates a medium having a temperature of 15° C. or less.

26. The food transportation system according to claim 23, wherein the first temperature medium and the second temperature medium is air wherein cool air and hot air is conveyed from the first temperature adjustment unit and the first temperature adjustment unit to the first food storage compartment and the second food storage compartment of the food transportation system.

27. The food transportation system according to claim 23, wherein the first food storage compartment is a hot compartment and is sized to from 50% to 90% of the size of the total compartment and the second food storage compartment is a cold compartment and is sized to from 10% to 50% of the size of the size of the total compartment; and wherein the lid comprises two center-hinged lids wherein one center-lid covers the hot compartment and one center-lid covers the cold compartment.

28. The food transportation system according to claim 23, wherein the first food storage compartment is a hot compartment and is sized to from 70% to 80% of the size of the total compartment and the second food storage compartment is a cold compartment and is sized to from % to 30% of the size of the size of the total compartment; wherein the lid comprises two center-hinged lids and wherein one center-lid covers the hot compartment and one center-lid covers the cold compartment, the food transportation system further comprises one or more phase change materials having a phase transition temperature corresponding to a desired delivery temperature of the food; one or more thermally insulating materials disposed in, or forming interior or exterior walls of, the one or more food storage compartments; an indicator light for showing the status of a phase change material in a charged or uncharged state; a magnetic closure for the food storage compartment, including, optionally, a positive closure mechanism; one or more additional food storage compartments and/or one or more additional phase change materials for storing and/or transporting a food at a temperature different from the desired delivery temperature; and one or more security and/or monitoring hardware and/or software items, including, optionally for controlling and/or monitoring the opening and closing of a food storage compartment.

29. Use of the food delivery temperature charging system, temperature charging cradle system or food transportation system of claims 1, 14, or 23, wherein the portable devices include delivery vehicles, aircraft including commercial, military, private and transportation aircraft, transportation trucks, water ships including passenger and freighter ships, trains, and fixed devices including restaurants, hotels and hotel rooms, entertainment locations, educational facilities, offices, and homes.

30. A device including portable and fixed devices comprising the food delivery temperature charging system, temperature charging cradle system or food transportation system of any of claims 1, 14 or 23, wherein the portable devices include delivery vehicles, aircraft including commercial, military, private and transportation aircraft, transportation trucks, water ships including passenger and freighter ships, trains, and fixed devices including restaurants, hotels and hotel rooms, entertainment locations, educational facilities, offices, and homes.
